(19) United States
(12) Patent Application Publication
(10) Pub. No.: US 2024/0037254 A1
(43) Pub. Date: Feb. 1, 2024

(54) GENERATING DATA COMPLIANCE CONSTRAINTS

(71) Applicant: Cisco Technology, Inc., San Jose, CA (US)

(72) Inventors: Marcelo Yannuzzi, Vufflens-La-Ville (CH); Arash Salarian, Chardonne (CH); Herve Muyal, Gland (CH); Jean Andrei Diaconu, Gaillard (FR); Jelena Kljujic, Deinze (BE); Carlos Goncalves Pereira, Carlsbad, CA (US)

(21) Appl. No.: 17/877,495

(22) Filed: Jul. 29, 2022

(51) Int. Cl. G06F 21/62; G06F 3/04847; G06F 40/279; G06F 40/166

(52) U.S. Cl. CPC G06F 21/6209; G06F 3/04847; G06F 40/279; G06F 40/166; G06Q 50/265

(57) ABSTRACT

In one embodiment, a device may extract, from one or more bodies of text, a data usage restriction for a particular type of data. The device may send, to a user interface, the data usage restriction extracted from the one or more bodies of text for presentation for a user. The device may receive, via the user interface, feedback from the user regarding the data usage restriction. The device may generate a data compliance constraint that controls how an application service handles the particular type of data, based on the data usage restriction and the feedback from the user.

### TECHNICAL FIELD

The present disclosure relates generally to generating data compliance constraints.

### BACKGROUND

Applications operate by handling data. For instance, executing an application can involve the storage, communication, processing, etc. of various types of data. The various types of data may include data whose handling is subject to various regulations. For example, data handling regulations at national, federal, state, industry, and/or organizational levels may be applicable to the data handled by an application.

The enforcement of data compliance has only been made more complex and potential violations made more likely as applications are increasingly being developed as a set of distributed services running across a mix of multi-cloud and edge infrastructures, handling a mix of data types differentially subject to various regulations, and/or being utilized by mobile endpoints. Unfortunately, following deployment of an application, enforcement of data compliance requirements largely occurs non-specifically and in a programmatic blind-spot. Given the current regulatory environment and trends, continuing to treat data compliance as an afterthought in this manner will likely yield increased violations of data compliance regulations which may result in substantial fines, penalties, and/or other negative impacts to data handlers.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example architecture for data compliance;

FIG. 4 illustrates an example architecture for extraction of data usage restrictions and generation of data compliance constraints;

FIG. 5 illustrates another example architecture for extraction of data usage restrictions and generation of data compliance constraints;

FIG. 6 illustrates an example architecture and procedure for automated inference and generation of data compliance constraints; and

FIG. 7 illustrates a simplified procedure for generating data compliance constraints.

### DESCRIPTION OF EXAMPLE EMBODIMENTS

### Overview

According to one or more embodiments of the disclosure a device may extract, from one or more bodies of text, a data usage restriction for a particular type of data. The device may send, to a user interface, the data usage restriction extracted from the one or more bodies of text for presentation for a user. The device may receive, via the user interface, feedback from the user regarding the data usage restriction. The device may generate a data compliance constraint that controls how an application service handles the particular type of data, based on the data usage restriction and the feedback from the user.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

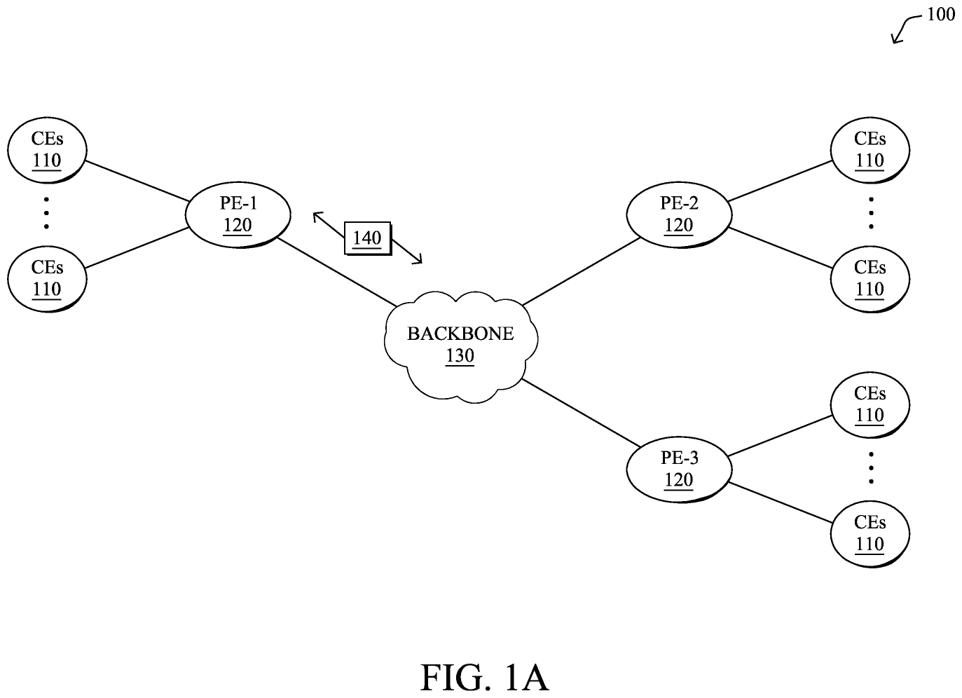

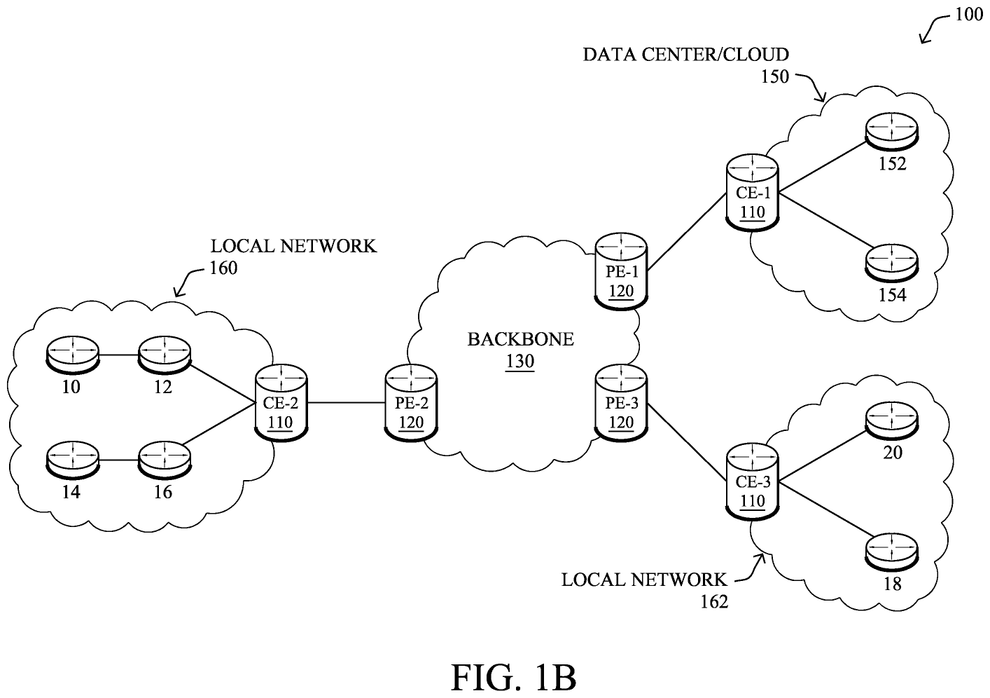

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B 1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

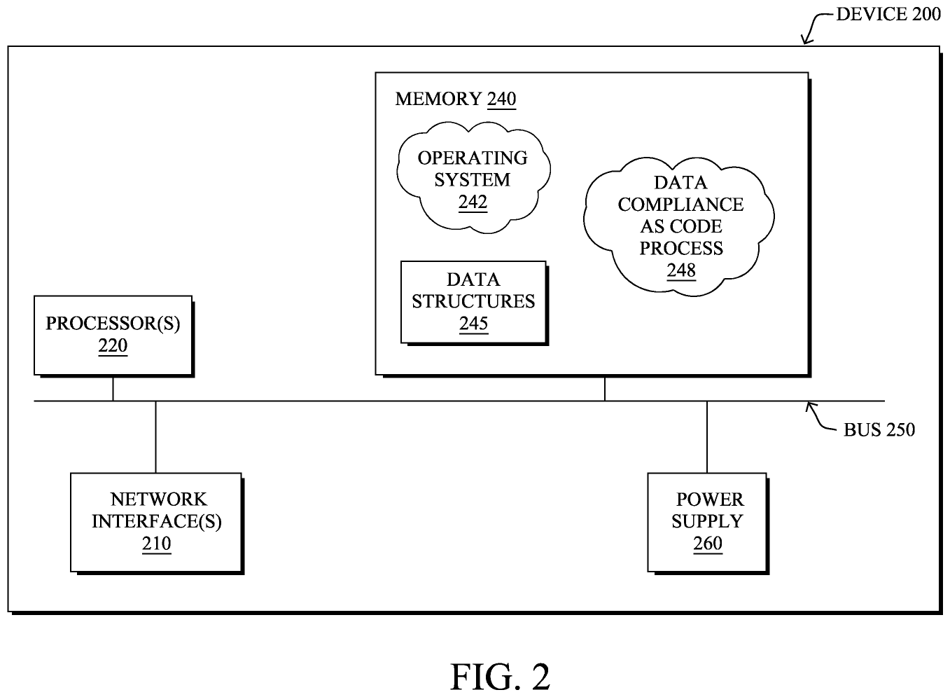

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise data compliance as code process 248, as described herein, any of which may alternatively be located within individual network interfaces.

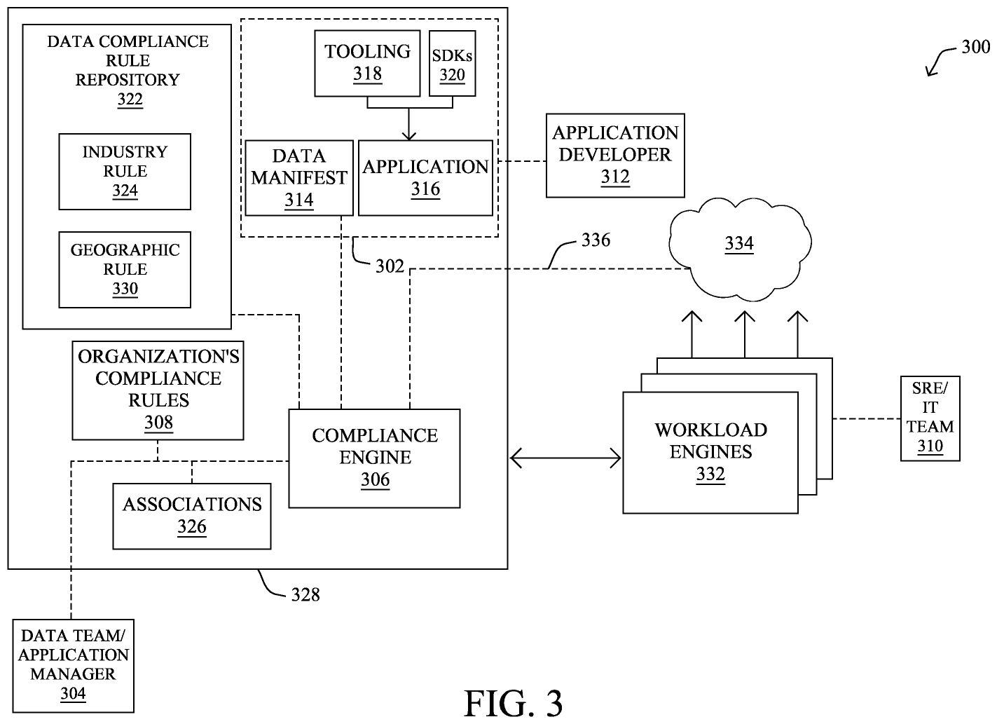

FIG. 3 illustrates an example architecture 300 for data compliance, according to various embodiments. The architecture 300 may include a data compliance as code process 328. Data compliance as code process 328 may be utilized to provide configuration, observability, and enforcement of data compliance rules. Data compliance as code process 328 may accomplish these functions utilizing Data Compliance as Code (DCaC).

DCaC may include integrating a data compliance mechanism into the program code of an application and/or application service. For example, data compliance as code process 328 may be utilized to build data compliance into the application development process, supported by automated code annotations, bindings between such annotations and categories of sensitive data, and controls at code, build, and pre-deploy time. Data compliance as code process 328 may provide a mechanism whereby application developers proactively assist data teams, application managers, and legal departments with data compliance, while ensuring that developers may remain oblivious to specific regulations, data related obligations, or compliance requirements that organizations might have across different regions.

For example, data compliance as code process 328 may include data annotating process 302. Data annotating process 302 may facilitate application developer 312 automatically adding metadata to program code of an application 316 during the development of the application 316. In various embodiments, this may be performed by automated annotations of data fields in the program code and by the creation of references to such annotations at code-build time. These references to annotated code may be automatically rendered in the form of machine-readable data manifest 314.

More specifically, data annotating process 302 may provide a mechanism for automated annotations of the program code of application 316, including classes, application programming interfaces (APIs), and the resulting data at code/build time (e.g., by implementing a Low-Code/No-Code approach supported by software development kits (SDKs) 320 and tooling 318). Application developers may utilize SDKs 320 and tooling 318 to automatically label data topics, data producers, data consumers, data processors, data holders, etc. For instance, developers may label certain data by annotating it with a data type identifier. For example, a developer may annotate certain data as “protected-type-1,” or other data as “protected-type-2,” and so on.

SDKs 320 in data annotating process 302 may provide a set of predefined data types out-of-the-box, including associations by default to specific categories of sensitive data. Sensitive data may include a type of data that may be considered personal, private, sensitive, confidential, protected, secret, restricted, personally identifiable information (PII), etc. In some examples, sensitive data may include data that is subject to regulation. For example, Table 1 lists examples of predefined protected data types and default associations to some examples of categories of sensitive data.

TABLE 1

| PROTECTED DATA TYPE | DEFAULT ASSOCIATION |
|---|---|
| protected-type-1 | Customer PII |
| protected-type-2 | Employee PII |
| . . . | . . . |
| protected-type-23 | Patient Analysis Results |
| . . . | . . . |
| protected-type-41 | Sales Confidential |
| . . . | . . . |
| protected-type-56 | Restricted HR |
| . . . | . . . |
| unprotected | NA |

A list of the associations, such as the example illustrated in Table 1, may provide associations by default to several categories of sensitive data, including but not limited to PII, confidential, restricted, and unprotected data. In some embodiments, the set of predefined protected data types might be standardized or rely on an existing taxonomy.

SDKs 320 in data annotating process 302 may also provide a mechanism to define and use custom data types in annotating program data of the application 316. For example, custom data types may be utilized, which identify protected data types that are not covered by any of those available by default in SDKs 320. For example, “custom-type-1” might be a custom data type associated to a category of sensitive data such as “Restricted Employee Poll.” In various embodiments, the generation and/or insertion of the annotations into the program code of the application 316 may be accomplished by an automated process (e.g., a programmatic identification of data of a particular data type triggering an automated insertion of an annotation of the data as the particular data type, etc.), a partially automated process (e.g., a programmatic flagging of data of a particular data type with a supervised or manual annotation of the data as the particular data type, etc.), and/or a manual process (e.g., a manual flagging of data of a particular data type and/or a manual annotation of the data as the particular data type, etc.).

In various embodiments, associations between protected data types and categories of sensitive data may be assigned and/or instrumented by different organizations and at different moments in time. In some cases, the association between protected data types and categories of sensitive data may be assigned by application developers 312 at code/build time. This might be the case when the team of application developers 312 is part of, or develops for, the organization that may use or manage the application 316. In such cases, the team of application developers 312 might have sufficient knowledge about the data and their use, so that they may either use the associations provided by default or create custom ones.

In additional instances, application developers 312 of application 316 and/or the users of the application 316 might belong to different organizations. For example, this may be the case when application developers 312 are a DevSecOps team that develops an application 316 that may be used across different organizations, industries, etc. In such cases, application developers 312 may be unaware of the categories of data that should be assigned by a data team and/or application manager 304 in another organization (e.g., precisely what data is confidential and what data is not with respect to that organization and its use of the application 316). In these instances, application developers 312 may leverage SDKs 320 and tooling 318 to approach data labeling and association in a manner that sidesteps the knowledge deficit while still instilling the functionality. For example, the application developers 312 may leverage SDKs 320 and tooling 318 to automatically add the different classes of protected data type at code and build time (e.g., utilizing predefined and custom protected data types). Additionally, or alternatively, the application developers 312 may leverage SDKs 320 and tooling 318 to automatically insert references in the form of machine-readable descriptions for the protected data types that may be used to generate data manifest 314 bound to application 316 at build time.

The protected data type annotations and their corresponding references may be utilized by a data team and/or application manager 304 in another organization to select and/or create automated associations 326 between categories of annotated data in the application 316 (e.g., metadata provided by application developers 312) and specific categories of sensitive data (e.g., personal data, private data, sensitive data, confidential data, protected data, secret data, restricted data, PII, etc.). For instance, each protected data type might be bonded to a class of tokens (e.g., JSON Web Tokens with a specific scope), which in turn might represent different categories of sensitive data for a data team and/or application manager 304.

In a specific example, an API call for application 316 may be labeled by application developers 312 with a data type identifier such as “custom-type-7” at code/build time. The “custom-type-7” labeled API call may attempt to access certain data using its bound token (e.g., “Token 7”) with a scope defined by, for example, a data team and/or application manager 304 before application 316 was deployed. From the data team and/or application manager 304 perspective, the attempt to access this data may translate to a request to access, for instance, “Confidential Partner” data. As such, the data type labels, and their associations may be utilized as an automated data mapping between the programmatic operations of application 316 and the sensitive data implicated in those operations. In various embodiments, these associations and functionalities may be supported by compliance engine 306 based on the selection, configuration, and automation of data compliance rules before application 316 is deployed and/or post-deployment.

In some examples, application developers 312, which again may be a DevSecOps team, might opt for a hybrid approach to generating these associations. For example, this may be the case when making some custom associations between data types and categories of sensitive data or using those predefined in the system (e.g., “protected-type-1” to “Customer PII”) might not only be trivial for the application developers 312 but also may facilitate the task of a data team and/or application manager 304 in defining associations. However, other associations might not be apparent to application developers 312. Hence, certain data in application 316 may be labeled as “protected types” along with their corresponding machine-readable descriptions in data manifest 314, though they may remain unassigned to a specific category of sensitive data, so they can be associated later by a data team and/or application manager 304 before the application is deployed, or by an automated data lineage, classification, and tagging process at run time (e.g., during the testing phase, that is, before the application is deployed in production).

In some embodiments, a data team and/or application manager 304 may be provided with a mechanism to change the associations created by application developers 312 or even associate more than one category of sensitive data to a given data type (e.g., a data team and/or application manager 304 may associate certain data with both “Employee PII” and “Confidential Data”). Hence, two categories of data compliance policies (e.g., one for “Employee PII” and another for “Confidential Data”) may apply and restrict even further the access to this category of data. In general, a data team and/or application manager 304 may be able to Create, Read, Update, or Delete (CRUD) any association between the metadata provided by application developers 312 and categories of sensitive data.

In various embodiments, a data team and/or application manager 304 may proactively create a set of custom data types. A data team and/or application manager 304 may provide the set of custom data types to application developers 312. Application developers 312 may then utilize the set of custom data types so that application 316 is annotated at development based on guidelines (e.g., the set of custom data types, etc.) provided beforehand by the data team and/or application manager 304.

In additional embodiments, application developers 312 and a data team and/or application manager 304 may collaborate to annotate application 316. For example, application developers 312 and a data team and/or application manager 304 may iterate in the annotation and association processing in an agile manner. For example, the iteration may be performed as part of a continuous integration/continuous delivery (Cl/CD) pipeline (e.g., at testing, staging, and production).

In some examples, application 316 may be composed of several services developed with different programming languages. Therefore, application 316 may utilize different SDKs 320. In some instances, the annotation methods and terminology applied to application 316 may vary depending on the programming language (e.g., usually referred to as attributes in C #, decorators in Python, annotations in Golang, etc.). In such cases, tooling 318 of data annotating process 302 may examine the different predefined and custom data types used with different SDKs 320, perform checks, and ensure consistency in the annotations and enumeration across the different services at build time. For example, these consistency checks may ensure that a given “custom-type-X” data type identifier represents the same type of data across services programmed using different programming languages even if they were programmed by different developers. Overall, the data annotating process 302 may provide different degrees of freedom to application developers 312, data teams and/or application managers 304, and the number of protected data types used, and their corresponding associations may vary depending on the type of application 316.

Data annotating process 302 may, as described above, be utilized in generating automated data references. Specifically, data annotating process 302 may automatically render a data manifest 314 bonded to application 316 at build time. Data manifest 314 may provide machine-readable descriptions of the predefined and/or custom data types used by application 316. A combination of SDKs 320 and tooling 318 may facilitate the instrumentation and automation of the program code at build time, including the automated rendering of data manifest 314. In some cases, application 316 may be composed of various containers. Each container may be built and packaged with its own data manifest, such that the final data manifest rendered for application 316 may be a composition of the individual data manifests. In some cases, application 316 may include dependencies on external services, such as a MySQL database. Such dependencies may be captured as a dependency manifest. Data fed, processed, retained, or retrieved from these external services may also be annotated and automatically captured in application 316 data manifest 314.

Data annotating process 302 may, as described above, be utilized for decoupling data compliance from the business logic of application 316. For example, SDKs 320 and tooling 318 of data annotating process 302 may provide automated mechanisms for decoupling the configuration, observability, and enforcement of data compliance rules from the business logic of application 316. In some instances, application 316 may be a cloud/edge native application, which may be implemented as a set of workloads composing a service mesh. The decoupling of data compliance from the business logic may be especially relevant for applications of this type, as geographically dispersed and/or variably deployed workloads may implicate increased data compliance complexity.

Various possible embodiments for decoupling data compliance from the business logic of application 316 may be utilized. For instance, a sidecar model, where the services that implement the business logic of application 316 are deployed together with sidecar proxies associated to each of those services, may be utilized. The sidecar proxies may be utilized to enforce horizontal functions that are independent of the business logic, such as routing, security, load balancing, telemetry, retries, etc. As such, the sidecars may be well-positioned to decouple, observe, and control data compliance. For example, a combination of distributed data compliance controllers and sidecar proxies may be used to configure, observe, and enforce data compliance rules across different geographies, and distributed multi-cloud and edge infrastructures 334.

Instead of, or in addition to, using sidecars, various embodiments may use client libraries, daemons working in tandem with the application-specific services, or sandboxed programs in the OS kernel, e.g., using the Extended Berkeley Packet Filter (eBPF). Further embodiments may use an agentless approach or embed such functionality in Kubernetes itself. In any case, the functionality introduced herein may enable the portability and reuse of observability and enforcement of data compliance functions across not only different applications but also cloud and edge environments.

The above-described data annotating process 302 may yield a portable annotated application 316 that is geared with built-in annotations for different types of protected data. In addition, the yielded annotated application 316 may be structured to operate while remaining agnostic of any state, country, industry, organization-specific regulation and/or data policy requirements that a data team and/or application manager 304 might have. As a result, data annotating process 302 may be leveraged as a new model of building applications including DCaC by not only data teams and/or application managers 304, but also software as a service (SaaS) providers and others.

Data compliance as code process 328 may provide configuration, observability, and enforcement of data compliance rules. As described above, associations 326 between categories of annotated data in application 316 and specific categories of sensitive data may be instrumented prior to a deployment of application 316. The associations 326 may be used to control the processing and use of data during and after the deployment of application 316. More specifically, compliance engine 306 may utilize associations 326 together with current data compliance regulations governing data handling in each region where application 316 may be used, as well as a specific organization's compliance rules 308 for/while using application 316, to enforce compliance with them. Such controls may apply to data access requests, data storage and retention policies, data processing requirements, etc. of application 316 both at deploy and execution time, etc.

To this end, data compliance as code process 328 may include data compliance rule repository 322. Data compliance rule repository 322 may provide a repository of data compliance rules. A data compliance rule may include a data usage restriction such as an industry/company/legal standard, an industry/company/legal regulation, an industry/company/legal preference, an industry/company/legal policy, an industry/company/legal obligation (contractual or otherwise), a statute, a court ruling, and/or any other expression of an industry/company/legal data usage restriction. The data usage restriction may be geography-specific, jurisdiction-specific, company-specific, client-specific, industry-specific, data type-specific, etc.

For example, data compliance rules repository 322 may include a repository of industry rules 324 which may be applicable to the use of application 316 within a specific industry. For example, with respect to instances where application 316 is used by a healthcare provider, data compliance rule repository 322 may include industry rules 324 such as Health Insurance Portability and Accountability Act of 1996 (HIPAA) regulations applicable to handling of data in the healthcare industry. In other examples, data compliance rule repository 322 may include a repository of geographic rules 330 which may be applicable to the use of application 316 within a specific geographical location. For example, with respect to instances where application 316 is based in a member state of the E.U., data compliance rules repository 322 may include geographic rules 330 such as the GDPR applicable to handling of data in the E.U.

The data compliance regulations included in data compliance rules repository 322 may be consumed by a data team and/or application manager 304 as a service (aaS). Data compliance rules repository 322 may support input, expression, collection, approval, visualization, and/or use of data compliance policies covering multiple categories of rules. The data compliance policies may include restrictions to the use of particular types of data. For example, data compliance rules repository 322 may store data compliance policies that are specific to an industry, those that may apply at a national, multi-national, federal, state, and industry levels, etc. For instance, an organization (e.g., a multi-national company) may leverage a data compliance rules repository 322 service of a data compliance as code process 328 and utilize the rules already available in data compliance rules repository 322, which may cover regulations across several industries and countries out-of-the-box. An organization may select the target state, country or region, the industry if needed, and select the data compliance regulations that may be applicable at the organizational level (e.g., organization's compliance rules 308).

Compliance engine 306 may offer APIs and a user-friendly user interface (UI) through which a data team and/or application manager 304 may select and define data compliance requirements. For instance, if application 316, which handles Customer PII data, needs to be deployed in British Columbia, Canada, a data team and/or application manager 304 may simply select “Customer PII→Apply Local Rules” to constrain the processing, storage, retention, and access to Customer PII data according to the regulations in British Columbia as retrieved from data compliance rules repository 322. To this end, compliance engine 306 may compute and handle the resulting constraints that apply to Customer PII data in British Columbia transparently to data teams and/or application managers 304. More specifically, the set of data compliance constraints may be captured in a machine-readable format from data compliance regulation repository 322, and therefore, used by compliance engine 306 programmatically.

In some examples, compliance engine 306 may be utilized as a pluggable module working in tandem with one or more workload engines 332, such as Cisco Intersight, Hashicorp Nomad, or other automation tools offered by cloud and edge solution providers. Workload engines 332 may manage the deployment of application 316, subject to the rules and constraints provided by compliance engine 306.

In various embodiments, compliance engine 306 may operate either in a push or a pull model. For instance, in a pull model, a workload engine 332 may receive a request to deploy application 316 in a given region (e.g., a request from a site reliability engineering (SRE) and/or information technology (IT) team 310). In such a case, workload engine 332 may issue a request to compliance engine 306, to compute and return data compliance rules and constraints that must be applied for their specific deployment. Alternatively, in a push model, a data team and/or application manager 304 may select the compliance rules required and a declarative intent for application deployment may be issued from compliance engine 306 to one or more workload engines 332. Such deployments may involve multi-cluster service meshes, which may run across multi-cloud and edge infrastructures 334. In various embodiments, the above-described sidecar proxies in the service mesh may not only provide monitoring and observability of data compliance to compliance engine 306 but also may receive configuration and compliance updates in real-time 336. In additional embodiments, the same functionality may be implemented utilizing client libraries, daemons, eBPF, an agentless approach, or Kubernetes itself. In addition, some embodiments may support the techniques described herein without utilizing a service mesh.

As noted above, the number and scope of laws and regulations regarding the processing, storage, and use of certain types of data are continually increasing across the world. For instance, the General Data Protection Regulation (GDPR) in Europe places strict requirements on how a user's personal data is collected and processed throughout its lifecycle. The GDPR has extraterritorial reach (e.g., it applies to entities outside of the EU) and includes broad definitions of personal data and equally broad definitions of processing activities. These and other requirements have spawned independent efforts across several countries to ensure that modern applications comply with specific data regulation at national, federal, or state level, particularly, those that are cloud delivered.

Legal uncertainty in the eye of accelerated digital transformation has resulted in concerns around cross-border data transfers and has given rise to “data localization” trends including its most severe form “data sovereignty”. This dynamic is posing complex challenges to the organizations that process and manage the application data, since legal obligations and constraints often vary from country to country. The challenge is even greater since data compliance requirements are usually not limited to data sovereignty obligations.

Depending on the type of application, data compliance may involve the amalgamation of other requirements. For example, data compliance may involve industry-specific rules (e.g., complying with HIPAA obligations in the healthcare industry in the US), or organization-specific rules (e.g., on how to handle confidential information, i.e., data that might not be regulated by the law).

Similarities in terminology and semantic relatedness may exist between the various concepts that are subject to data protection and/or other data regulations across the world. However, determining the set of data compliance constraints that must be applied when application data is jointly subject to data sovereignty obligations, industry-specific regulation, and organization-specific rules remains a complex, manual, and labor-intensive task.

For instance, data teams in multinational corporations may work with legal counsel to constantly interpret any relevant regulation or gain specialized expertise on the resulting constraints. The collaborative interpretations may be relied upon to continuously keep such knowledge up-to-date as new regulations arise or existing ones are updated. This costly and labor-intensive approach to keeping abreast of regulatory landscapes often fails to produce a reliable regulatory knowledgebase as the volume of information to be processed and diversity of expertise, knowledge, and organizational familiarity involved in building and modifying a holistic regulatory knowledgebase may be outside the capacity of an individual or team.

Generating Data Compliance Constraints

The techniques herein introduce mechanisms to programmatically extract data usage (e.g., sending, receiving, storing, processing, transforming, etc.) restrictions from various possible sources, along with the automated inference of actionable data compliance rules for applications subject to data sovereignty and other compliance rules, which may apply across different geographical locations, multi-cloud, and edge. These techniques may utilize commonalities, wide reuse of terms, and semantic relatedness between various concepts that are subject to data protection and regulations across different regions and industries.

Illustratively, the techniques described herein may be performed by hardware, software, and/or firmware, such as in accordance with data compliance as code process 248, which may include computer executable instructions executed by the processor 220 (or independent processor of interfaces 210) to perform functions relating to the techniques described herein.

Specifically, according to various embodiments, a device may extract, from one or more bodies of text, a data usage restriction for a particular type of data. The device may send, to a user interface, the data usage restriction extracted from the one or more bodies of text for presentation for a user. The device may receive, via the user interface, feedback from the user regarding the data usage restriction. The device may generate a data compliance constraint that controls how an application service handles the particular type of data, based on the data usage restriction and the feedback from the user.

Operationally, and according to various embodiments, the techniques described herein may be utilized to extract information programmatically from data usage restrictions and turn such knowledge into actionable constraints that workload engines and/or other systems can parse and use.

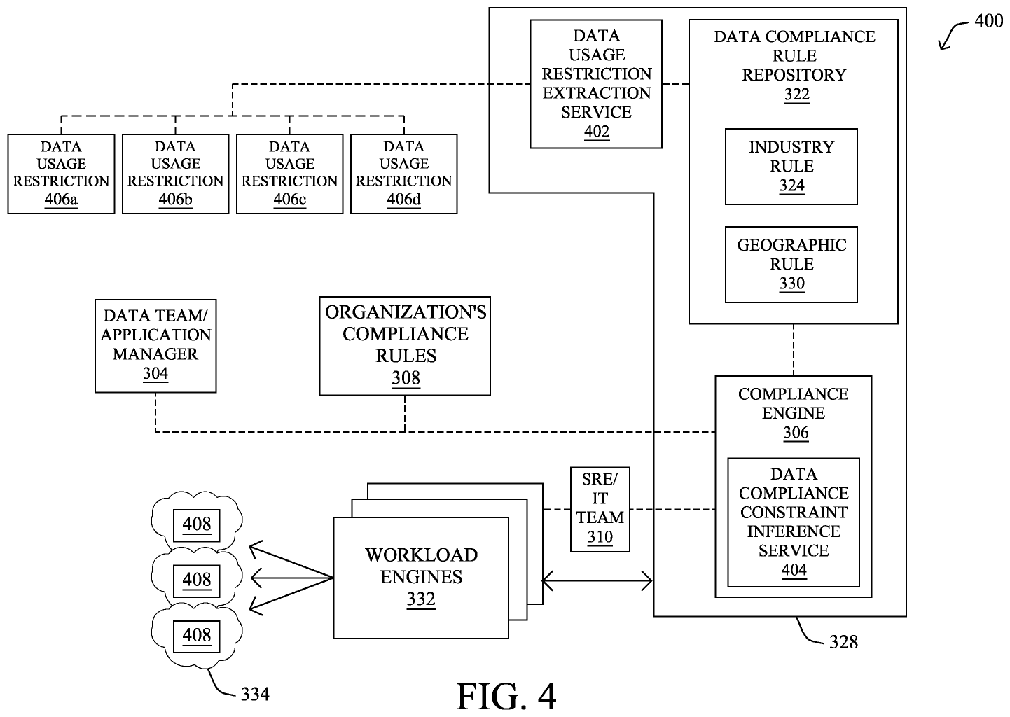

FIG. 4 illustrates an example architecture 400 for extraction of data usage restrictions and generation of data compliance constraints, in accordance with one or more embodiments described herein. The architecture 400 may include a data compliance as code (DCaC) process 328. As described above, DCaC process 328 may include data compliance rule repository 322 supporting compliance engine 306 in programmatically generating data compliance constraints to be applied to workload engines 332 in spinning up clusters supporting application workloads 408 across multi-cloud and/or edge infrastructures 334.

As described above, compliance engine 306 may enable data team and/or application manager 304 to enter and/or manage data compliance requirements of an organization. For instance, if an application that handles Personally Identifiable Information (PII) needs to be deployed in Brazil, data team and/or application manager 304 may simply select “PII→Apply Local Regulation”, and compliance engine 306 may compute and generate the resulting constraints that apply to PII in Brazil transparently to data team and/or application manager 304. More specifically, the set of data compliance constraints may be captured in a machine-readable manner, and therefore, may be used by compliance engine 306 programmatically.

Data compliance rule repository 322 may provide the repository of rules, both in machine-readable and human-readable formats, which may be consumed by data team and/or application manager 304, legal counselors, external systems as a service (aaS), etc. through DCaC process 328. In addition to any rules already available in the data compliance rule repository 322, which may cover regulations across several industries and/or geographic locations out-of-the-box, data compliance rule repository 322 may be populated with data compliance rules (e.g., data usage restrictions) programmatically extracted from various sources.

In various embodiments, a data usage restriction extraction service 402 may programmatically process data usage restrictions and/or other regulatory data from a variety of sources. For example, data usage restriction extraction service 402 may programmatically process any of a variety of expressions of data usage restrictions 406. Expressions of data usage restrictions 406 may include records of data usage restrictions (e.g., rules, regulations, statutes, laws, treaties, legislative records, court decisions, guidelines, policies, preferences, best-practices, contracts, communications, obligations, etc.). The records may include audio records, visual records, text records, digital records, documents, files, posts, etc. In some examples, the records may include bodies of text such as words, sentences, paragraphs, pages, volumes, etc.

For example, expressions of data usage restrictions 406 may, in some examples, be industry-specific regulation documents (e.g., expression of data usage restriction 406d). An industry-specific regulation may include a regulation specific to industries such as third-party data suppliers, education institutions, financial services, medical/healthcare institutions, energy/utility providers, etc.

Expressions of data usage restrictions 406 may include data type-specific regulation documents (e.g., expression of data usage restriction 406c). For example, data type-specific regulation documents may include documentation of regulations covering the handling of personal data. A personal data regulation document may include documentation of data usage restrictions (e.g., GDPR, CCPA, an omnibus personal data regulation document, etc.) for handling personally identifiable information (PII) and/or other personally distinguishable sensitive data.

In addition to being specific to an industry or data type, expressions of data usage restrictions 406 may be geolocation specific. For example, expressions of data usage restrictions 406 may be specific to an industry within a geographic location, specific to using a data type within a geographic location, etc.

Expressions of data usage restrictions 406 may, in some examples, be ontology-based online forms (e.g., expression of data usage restriction 406b). The online forms may capture industry specific, data type specific, etc. data usage restrictions.

Additionally, or alternatively, expressions of data usage restrictions 406 may, in some examples, be an ontology (e.g., expression of data usage restriction 406a) capturing industry specific, data type specific restrictions, etc. data usage restrictions.

Data usage restriction extraction service 402 may extract the corresponding data usage restrictions from expressions of data usage restrictions 406. For example, data usage restriction extraction service 402 may utilize various data sources and programmatic techniques which may employ various statistical and/or non-statistical mechanisms of data extraction to extract the data usage restrictions.

Data usage restriction extraction service 402 may store the extracted data usage restrictions (e.g., as digests of extracted data usage restrictions) in a human-readable format and/or in a machine-readable format. The data usage restriction digests may be stored in data compliance rule repository 322.

The data usage restriction digests stored in data compliance rule repository 322 may be utilized, in addition to other compliance rules that might be required at the organizational level (e.g., organization's compliance rules 308), by workload engines 332 to deploy an application service. For example, compliance engine 306 may be utilized as a pluggable module working in tandem with workload engines 332, such as Cisco Intersight, Hashicorp Nomad, or other automation tools offered by cloud and edge solution providers. These workload engines 332 may manage the deployment of the application service, subject to the rules and constraints provided by compliance engine 306.

Compliance engine 306 might operate either in a push or pull model. For instance, in a pull model, workload engines 332 may receive a request to deploy an application in a given geographic region (e.g., from the SRE or IT team 310). In such examples, workload engines 332 may issue a request to compliance engine 306 to compute and return the data compliance constraints that must be applied for that specific deployment.

The inference and response of such data compliance constraints in an actionable manner may be supported by a data compliance constraint inference service 404 of compliance engine 306. Alternatively, in a push model a data team and/or application manager 304 may select the compliance rules required, and a declarative intent for deploying the application might be issued from compliance engine 306 to one or more of workload engines 332. If the application deployment performed by workload engines 332 is successful, this may result in the spin up of several clusters (e.g., a set of K8s or K3s clusters) supporting the application workloads 408 across multi-cloud and edge infrastructures 334.

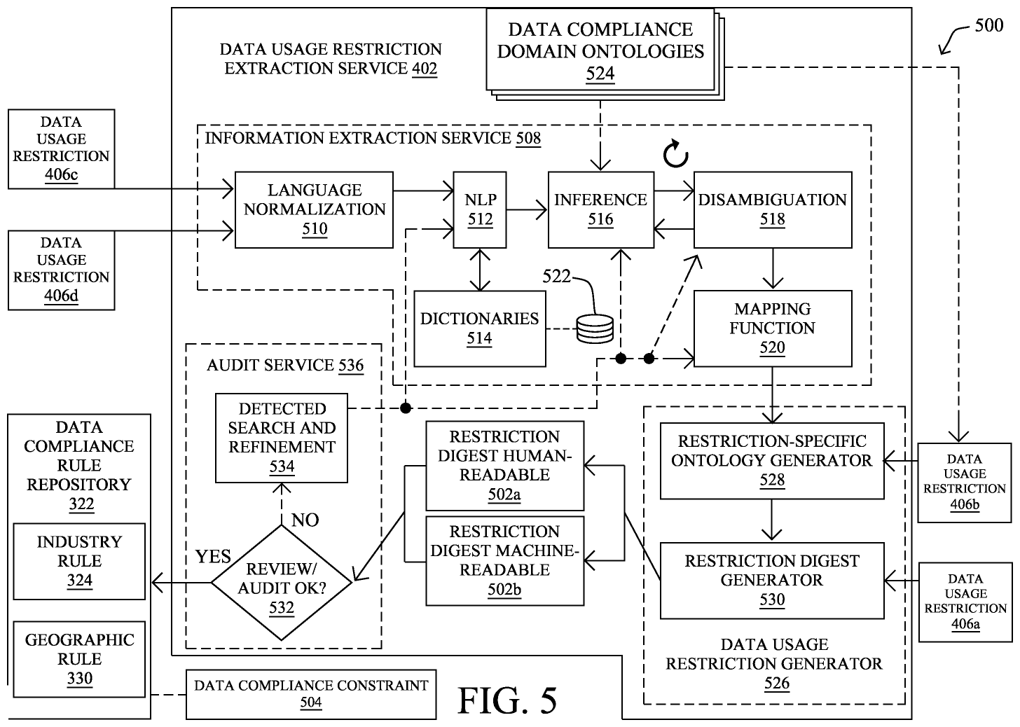

FIG. 5 illustrates another example architecture 500 for extraction of data usage restrictions and generation of data compliance constraints. For example, architecture 500 may be utilized to enable a programmatic extraction of data usage restrictions from various sources (e.g., expressions of data usage restrictions 406) and their storage in data compliance rule repository 322. The programmatic extraction of data usage restrictions may be performed utilizing statistical and/or non-statistical information extraction techniques.

In various embodiments, such as those employing statistical techniques to extract data usage restrictions, data usage restriction extraction service 402 may receive expressions of data usage restrictions 406 as inputs. The expressions of data usage restrictions 406 may include an industry-specific regulation document (e.g., expression of data usage restriction 406d) and/or a data type-specific regulation document (e.g., expression of data usage restriction 406c).

Data usage restriction extraction service 402 may process each of the expressions of data usage restrictions 406 independently. For each of the expressions of data usage restrictions 406, the resulting output may include one or more digest of data usage restrictions (e.g., data usage restriction digest 502) extracted from the expressions of data usage restrictions 406. For example, the output for expressions of data usage restrictions 406 may include a data usage restriction digest in a human-readable format (e.g., human-readable data usage restriction digest 502a) and/or a data usage restriction digest in a machine-readable format (e.g., machine-readable data usage restriction digest 502b).

Each data usage restriction digest 502 may include descriptions of data usage restrictions such as those extracted from the expressions of data usage restrictions 406. Data usage restriction digest 502 may be specific to and/or include data usage restrictions applicable to a specific geolocation and/or industry of an application service. Data usage restriction extraction service 402 may generate as many data usage restriction digest 502 as needed depending on the geolocation and/or industries of interest (e.g., the geographic location where an application service will operate and/or an industry associated with the application service).

Data usage restriction extraction service 402 may include information extraction service 508. Information extraction service 508 may include language normalization module 510. Language normalization module 510 may translate and bring different data usage restrictions from the expressions of data usage restrictions 406 to a common language. However, some embodiments may skip this step and/or exclude this module, instead relying on external means to achieve this translation. For instance, information extraction service 508 may be fed data usage restrictions in a common language (e.g., English).

Data usage restriction extraction service 402 may utilize natural language processing (NLP) techniques (e.g., executed by NLP module 512). NLP techniques may be used to perform natural language processing and transformation of the expressions of data usage restrictions 406. NLP techniques may be utilized to summarize and/or reformulate expressions of data usage restrictions 406 (e.g., one or more bodies of text therein) by leveraging one or more dictionaries 514.

Dictionaries 514 may capture and/or define the reference terminology and/or domain-specific lexicon of the subject expressions of data usage restrictions 406. Dictionaries may store relevant definitions on data regulation at state, province, country, multi-national, and industry-specific levels to access them from data structure 522.

A combination of inference process 516 and disambiguation process 518 may utilize a set of domain-specific data compliance ontologies (e.g., data compliance domain ontologies 524) and use techniques such as lexical matching, clustering, and semantic relatedness to identify the key concepts and relationships between such concepts in expressions of data usage restrictions 406. The pool of data compliance domain ontologies 524 may include one reference ontology for data protection regulation of a particular geographic area (e.g., at national level, state level, city level, etc.), another ontology for data regulation in a particular industry (e.g., the finance industry), another for data regulation in another industry (e.g., the healthcare industry), etc. These reference ontologies may generalize and/or comprehensively capture the set of concepts and possible relationships that may apply among such concepts for each knowledge domain, independently of any specific data usage restriction in that domain.

Such ontologies may comprise multiple layers and taxonomies, such as a “data types” or “data categories” layer, a “data actors” layer, a “data resource” layer, a “data operations” layer, a “data permissions” layer, a “data location” layer, etc. For example, in one ontology a concept in the “data types” or “data categories” layer (e.g., “PII”), might be semantically related to a concept in the “data operations” layer (e.g., “Data Processing”) through the property “CONSTRAINED TO”. Likewise, the concept “Data Processing” in the “data operations” layer might be semantically related to a concept in the “data location” layer (e.g., “Country”) through the property “WITHIN”. Hence, once possible set of relationships among concepts captured by the ontology could be: (PII)→CONSTRAINED TO→(Data Processing)→WITHIN→(Country). Mapping function 520 may identify and/or map the concepts and relationships that would be obtained from a specific data usage restriction that is being processed by the information extraction service 508 to those that semantically match in the reference (domain-specific) ontology (e.g., the corresponding ontology from data compliance domain ontologies 524).

Data usage restriction extraction service 402 may include data usage restriction generator 526. Data usage restriction generator 526 may utilize the outputs (e.g., from mapping function 520) of information extraction service 508 to generate an ontology specific to a data usage restriction being processed and/or to generate digests of data usage restrictions (e.g., data usage restriction digest 502). For example, data usage restriction generator 526 may render both human-readable data usage restriction digest 502a and machine-readable data usage restriction digest 502b.

For example, the mapping yield by mapping function 520 may be subsequently used by restriction-specific ontology generator 528 to prune the reference ontology (e.g., the corresponding ontology from data compliance domain ontologies 524) and produce an ontology that models the specific data usage restriction being processed by information extraction service 508. Each of the ontologies generated by restriction-specific ontology generator 528 might be represented as a sub-graph of the reference (domain-specific) ontology (e.g., data compliance domain ontologies 524). Hence, the newly generated ontology may capture the knowledge about the specific data usage restrictions contained in the expression of data usage restrictions 406 that is being processed.

The ontology computed by the restriction-specific ontology generator 528 may serve as an input to a restriction digest generator 530. Restriction digest generator 530 may render both human-readable data usage restriction digest 502a and machine-readable data usage restriction digest 502b from the data usage restrictions extracted from expressions of data usage restrictions 406. Data usage restriction digests 502 may include descriptions of and/or instructions for implementing their data usage restrictions as a constraint to a particular data type.

The techniques above described may utilize commonalities and semantic relatedness between the various concepts that are subject to data protection and regulations across different regions and industries. For example, GDPR is widely considered as a benchmark data handling regulation, so many of the existing data usage restrictions and upcoming ones may be inspired by a common set of principles within the GDPR. Indeed, many of them leverage the taxonomies, terminology, lexical semantics, and rules (or variants of them) present in GDPR. Similarly, industry-specific data usage restrictions also have clear commonalities across different regions. For instance, this data could be utilized as the basis to populate data structure 522 with reference terminology and data usage restriction data.

In addition, the solution space for data compliance constraints may be discrete, bounded, and sparse. For instance, a considerable number of data localization restrictions may be clustered into three groups regarding personal data: G1) those where data can be processed, stored, and accessed both within and outside the region of interest; G2) those where data must be stored within the region of interest, but they can be processed and accessed both within and outside the region of interest under certain data retention conditions; and/or G3) those where data must be processed, stored, and accessed exclusively within the region of interest. These characteristics may facilitate considerably the tasks of programmatically searching for and extracting data usage restrictions from expressions of data usage restrictions 406 and generating the corresponding data usage restriction digest 502.

Data usage restriction extraction service 402 may include audit service 536. Audit service 536 may operate in a semi-autonomous and/or autonomous mode. Audit service 536 may elicit and/or receive feedback from a user regarding the data usage restriction digest 502 generated from the extracted data usage restrictions.

For example, audit service 536 may send a human-readable data usage restriction digest 502a to a user for their review and/or provision of feedback. The feedback may include approval of data usage restriction digest 502, rejection of data usage restriction digest 502, modification of data usage restriction digest 502, removal of data usage restriction digest 502, further restriction of data usage restriction digest 502, lessening restriction of data usage restriction digest 502, commenting on data usage restriction digest 502, etc.

The feedback may be utilized to revise the data usage restriction digest 502. For example, the feedback may be utilized to steer specific modifications (e.g., more restrictive, less restrictive, more inclusive, less inclusive, etc.) to the data usage restriction digest 502 and/or to approve them before they are stored in data compliance rule repository 322.

When operating in a semi-autonomous mode, audit service 536 may send at least the human-readable data usage restriction digest 502a to a user for the user to provide feedback at 532. For example, audit service 536 may require a user such as an authorized legal counselor to approve the data usage restriction digest 502 generated by data usage restriction generator 526 and/or to supervise and/or request specific refinements to the obligations identified (e.g., via directed search and refinement module 534).

As previously noted, data compliance rule repository 322 may provide a comprehensive catalog of data usage restriction digests for different geographical locations, capturing both personal data and industry specific obligations selectively employable as data compliance constraints to application services. Since the resulting data usage restriction digests stored in data compliance rule repository 322 may be uniformly formatted, they may be available and delivered in machine-readable format. Therefore, the resulting data usage restriction digests may be inserted into data compliance rule repository 322 and consumed and/or used programmatically by compliance engine 306 or third-party systems. For example, the resulting rule digests and/or their component data usage restrictions may be consumable in machine-readable format as a service from data compliance rule repository 322. Thus, compliance engine 306 may pull a particular data usage restriction from data compliance rule repository 322 and utilize it as a data compliance constraint to be applied (e.g., via a workload engine 332) to the operation of an application workload 408.

In some examples, audit service 536 may automatically find data usage restriction digests already present in data compliance rule repository 322 from the same and/or similar geographies, industries, etc. and compare their classifications to the classifications of the data usage restriction digests 502. For example, audit service 536 may determine that the same and/or similar data usage restriction digests already present in data compliance rule repository 322 are either classified differently from the machine-readable data usage restriction digest 502b, constituting a conflicting classification, and triggering a reconciliation process which may involve notifying a user of the conflict and requesting additional feedback. Alternatively, audit service 536 may determine that the same and/or similar data usage restriction digests already present in data compliance rule repository 322 are either classified similarly or identically to machine-readable data usage restriction digest 502b, constituting a confirmation of the classification which may be utilized as permission to save the machine-readable data usage restriction digest 502b to data compliance rule repository 322 and/or to make it consumable therefrom as a data compliance constraint.

Various embodiments may include additional instrumentation and/or enforcement refinements to the data usage restrictions identified by information extraction service 508 and/or data usage restriction generator 526. For instance, audit service 536 may enable a user to edit the human-readable digest 502a and/or modify specific fields thereof. These modifications may be fed back (e.g., via directed search and refinement module 534) to information extraction service 508 and/or data usage restriction generator 526. The modifications may be utilized not only to regenerate data usage restriction digest 502 but also to train and/or refine information extraction service 508 in a semi-supervised fashion.

When operating in an autonomous mode, audit service 536 may operate as a combination of algorithmic and machine learning models that may fully automate the techniques of data usage restriction extraction service 402. For instance, audit service 536 may be fully automated to programmatically and/or autonomously review the machine-readable data usage restriction digest 502b. For instance, audit service 536 may be trained to detect deviations from a set of bounded outcomes (e.g., digests cannot confidently fit into any of the groups G1, G2 and G3 described above) and/or to find replications or contradictions in the digests (e.g., similar to finding conflicting or confirming classifications among existing restriction digests in data compliance rule repository 322, as described above). In such cases, a directed search and refinement module 534 may be triggered, enabling closed-loop operation and automated control between information extraction service 508, data usage restriction generator 526, and/or audit service 536 until a viable set (e.g., a non-conflicting and/or confirmed set) of data usage restrictions is found. Additional embodiments may rely on fully self-supervised training methods and backward feedback between modules until a viable set of obligations is found.

In contrast to the embodiments employing statistical techniques to extract data usage restrictions, various embodiments may alternatively, or additionally, employ deterministic (e.g., non-statistical) techniques to extract data usage restrictions from expressions of data usage restrictions 406. For instance, various embodiments may utilize the data compliance domain ontologies 524 themselves (i.e., the set of reference ontologies) along with non-statistical techniques to simplify the data usage restriction extraction service 402.

For instance, a user, such as an authorized legal counselor, may enter the data usage restrictions directly in the data usage restriction extraction service 402 by filling in an online form (e.g., expression of data usage restriction 406b). The form or forms that the user fills in may be internally structured according to the corresponding reference (domain-specific) ontology (e.g., an ontology from data compliance domain ontologies 524). Hence, once a form is duly completed and submitted, restriction-specific ontology generator 528 may directly process the corresponding fields and data entered, and automatically generate a regulation-specific ontology without requiring any statistical inference. More specifically, data usage restriction extraction service 402 may determine the rules deterministically, instead of statistically. Information extraction service 508 may still be used to prefill the form and/or to provide suggestions to assist and simplify the data entry tasks involved in manually completing such forms.

In some embodiments, information extraction service 508 may be simplified and reduced to only NLP module 512. NLP module 512 may utilize Pre-trained Language Models (PLMs), which may process the expressions of data usage restrictions (e.g., expression of data usage restriction 406c and expression of data usage restriction 406d) directly. In various embodiments, the outputs of this processing by NLP module 512 may be used to generate pre-filled forms (e.g., expression of data usage restriction 406b), which may be ready to be completed and reviewed by users, such as authorized legal counselors.

Additional embodiments may enable a Regulatory Entity (RE) or an authorized organization to proactively provide a corresponding ontology (e.g., expression of data usage restriction 406a) jointly with the expression of data usage restriction (e.g., expression of data usage restriction 406c, expression of data usage restriction 406d, etc.) that it is to be utilized to extract the data usage restrictions from. Such ontology may capture, in machine-readable format, the data compliance obligations in a specific data usage restriction. In addition, the ontology may be cryptographically signed by the RE and may be directly processable by data usage restriction generator 526.

Irrespective of whether the data usage restrictions were captured and conveyed via an ontology-based form (e.g., expression of data usage restriction 406b) or an ontology (e.g., expression of data usage restriction 406a) directly, data usage restriction extraction service 402 may be streamlined to solely data usage restriction generator 526 and a streamlined version of audit service 536. Hence, data usage restriction extraction service 402 may be utilized for programmatic extraction of data usage restrictions and their corresponding storage in data compliance rule repository 322, by combining both statistical and non-statistical information extraction techniques. Those skilled in the art would understand that the described use of forms and/or ontologies simply represent examples of possible embodiments. Alternative methods, including data models, files, or protocols could be used as well.

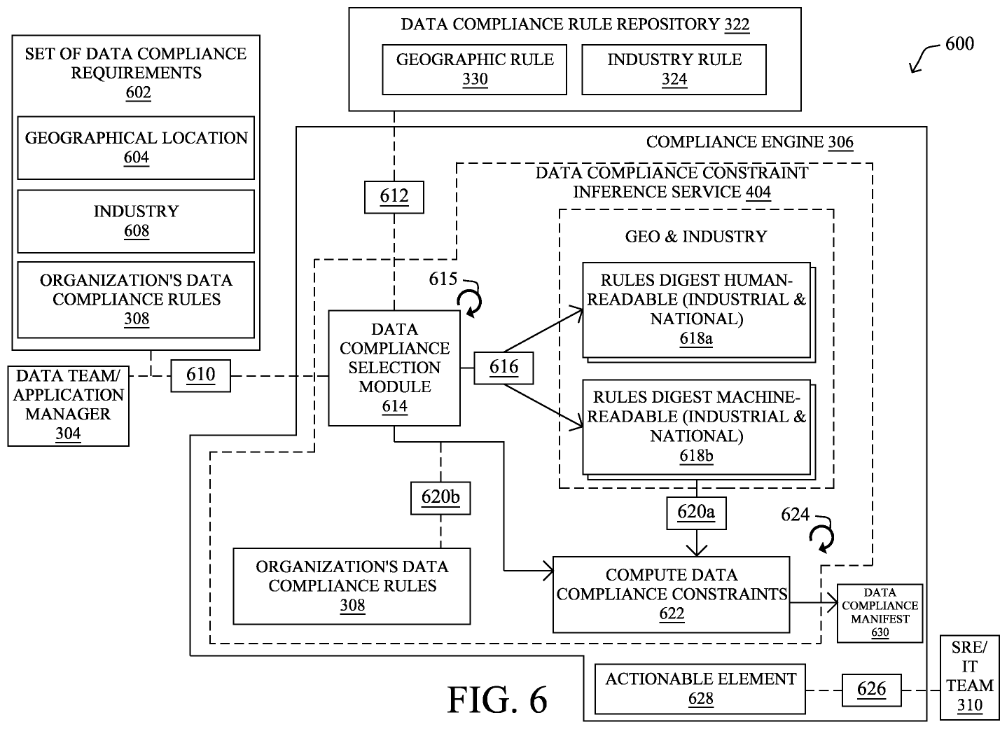

FIG. 6 illustrates an example architecture 600 executing automated inference and generation of data compliance constraints 630, in accordance with one or more embodiments described herein. Data compliance engine 306 may leverage the data compliance rule repository 322 to perform an automate inference of a data compliance constraint 630 (e.g., in day +1).

At 610, a data team and/or application manager 304 may submit a request for a deployment of an application service to data compliance engine 306. For example, once the data usage restrictions are generated and stored in data compliance rule repository 322 (e.g., in day −1), an organization may provide their data compliance requirements to data compliance engine 306 and let data compliance constraint inference service 404 automatically compute the corresponding data compliance constraints 630 applicable to a deployment of an application service. For instance, a data team and/or application manager 304 may enter a set of data compliance requirements 602 for a given application deployment. The set of data compliance requirements 602 may include the geographical location 604 where the application needs to be deployed, the industry 608 in which the application will operate, and/or a set of rules that the organization might require (e.g., organizations' compliance rules 308), including data processing, storage, retention, and access policies.

At 612, the request may be processed by data compliance selection module 614 of data compliance engine 306. Data compliance selection module 614 may identify the geographical location and the corresponding industry of the requested application service deployment. Data compliance selection module 614 may use these identified characteristics as inputs to retrieve the data usage restrictions applicable to the requested deployment. For example, data compliance selection module 614 may identify machine-readable restriction digests and/or human-readable restriction digests stored within data compliance repository 322 that restrict data usage having characteristics that correspond to and/or match the identified characteristics of the requested application service.

At 615, a user, such as a legal representative of an organization requesting a deployment of an application service, may revise the identified human-readable data usage restriction digests. For example, the user may approve or edit the identified human-readable restriction digests and the system may automatically update the corresponding machine-readable restriction digests to further restrict the data usage restrictions (e.g., to reduce the exposure and potential risk of the organization to future fines in case of a regulation infringement). For instance, while the identified machine-readable restriction digests and/or human-readable restriction digests may stipulate that certain data types must be stored within the region of interest, but they can be processed and accessed both within and outside the region of interest under certain data retention conditions (G2), a user may restrict this even further, and recommend to process, store, retain, and access the data exclusively within the region of interest (G3).

At 616, the revised and/or approved restriction digests 618 output from data compliance selection module 614 may be caused to be stored by data compliance selection module 614. The revised and/or approved restriction digests 618 may be stored both in a machine-readable format (e.g., machine-readable restriction digest 618b) and/or in a human-readable format (e.g., restriction digest 618a). The revised and/or approved restriction digests 618 may be those directly obtained from data compliance rule repository 322 or may represent a more restrictive or less restrictive version of those obtained from data compliance rule repository 322.

At 620, the machine-readable data usage restrictions specified in machine-readable restriction digest 618b may be used, at 620a, by compute data compliance constraints module 622, together with the organization's data compliance rules 308 retrieved from the set of data compliance requirements 602, at 620b, to compute the specific set of data compliance constraints 630 that should be applied to the application service. For instance, for “Personal Data”, such data compliance constraints 630 may stipulate that the processing, storage, retention, and access of this category of data must be restricted to “within the country”.

At 624, compliance engine 306 may have access to a catalog of candidate infrastructures that might be used for the application deployment (e.g., a pool of public cloud zones, a pool of public edge zones, a set of private cloud infrastructures, etc.). Such information may be accessible as part of a “pull” request coming from a workload engine 332, or it may be configured beforehand by an SRE/IT team 310, or it may be available through other means. In any case, the data compliance constraints 630 computed at 620 may be mapped to the available infrastructure to filter and identify those that are compliant, and subsequently generate a declarative intent to deploy the application service.

At 626, the declarative intent computed at 624 may be captured as a data compliance constraint 630. Data compliance constraint 630 may be included in an actionable element 628. Actionable element 628 may be a data manifest or other object, file, document, etc. including one or more data usage restriction. Actionable element 628 may be programmatically used by a workload engine 332 to enforce a data compliance constraint 630 against the application workloads whose deployment and/or execution they are managing. Enforcing the data compliance constraint 630 may include controlling, according to the data compliance constraint 630, how the application service handles a particular type of data specified in the data compliance constraint. For example, if the data compliance constraint 630 includes a data usage restriction such as PII data of the application service may only be utilized (e.g., processed, stored, used, communicated, transformed, etc.) within a particular geographic location, then the application service may be configured so that PII data, identifiable utilizing the DCaC mechanism, is limited to being utilized in the particular geographic location.

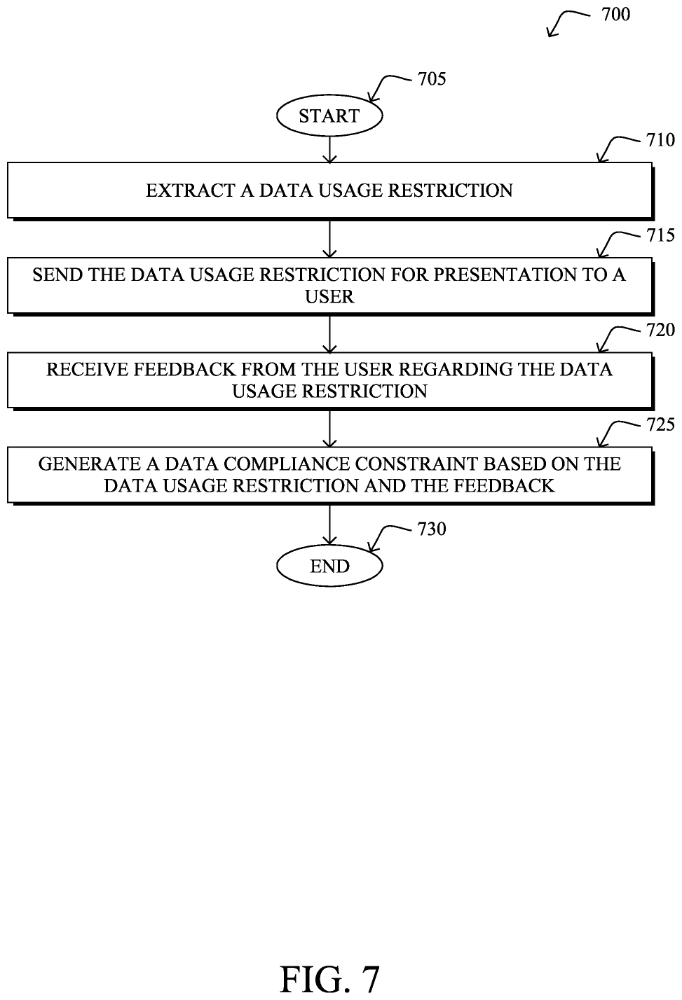

FIG. 7 illustrates an example simplified procedure (e.g., a method) for generating data compliance constraints, in accordance with one or more embodiments described herein. For example, a non-generic, specifically configured device (e.g., device 200), may perform procedure 700 by executing stored instructions (e.g., data compliance as code process 248).

The procedure 700 may start at step 705, and continues to step 710, where, as described in greater detail above, a device may extract, from one or more bodies of text, a data usage restriction for a particular type of data. The one or more bodies of text comprise a law, a regulation, an industry rule, etc.

The data usage restriction may be extracted from the one or more bodies of text by applying a domain-specific data compliance ontology to the one or more bodies of text. For example, the data usage restriction from the one or more bodies of data may be extracted based on an industry associated with the user. For example, an industry-specific ontology may be leveraged in identifying and extracting the data usage restrictions for a particular industry. Alternatively, or additionally, an industry-specific ontology may be leveraged in identifying and extracting the data usage restrictions for a particular geolocation. In addition, data usage restrictions may be extracted from ontology-based online forms or extracted directly from an ontology.

At step 715, as detailed above, a device may send, to a user interface, the data usage restriction extracted from the one or more bodies of text for presentation to a user.

At step 720, the device may receive, via the user interface, feedback from the user regarding the data usage restriction. The feedback may indicate an additional restriction to the data usage restriction. For example, the feedback may further restrict how the subject data type is handled by the application service and/or its users.

At step 725, where, as detailed above, the device may generate a data compliance constraint that controls how an application service handles the particular type of data based on the data usage restriction and the feedback from the user. The data compliance constraint may indicate one or more geolocations in which the particular type of data can be stored. The data compliance constraint may indicate one or more geolocations from which the particular type of data can be accessed. The data compliance constraint may indicate how the particular type of data can be utilized (e.g., processed, stored, used, communicated, transformed, etc.). The data compliance constraint generated by the device may be provided to a workload engine associated with the application service that manages a deployment of the application service to a networked infrastructure according to the data compliance constraint.

The data compliance constraint may be updated in response to detecting a change in the one or more bodies of text. For example, the one or more bodies of text may be continuously or periodically monitored in order to detect changes to the data usage restrictions. When a change is detected, the changed data usage restriction may be extracted and sent to a user interface for presentation to a user, where the user's feedback on the changed data usage restriction may be received and an updated data compliance constraint may be generated based on the changed data usage restriction and/or the user's feedback.

Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

In the absence of these techniques, organizations suffer from poor automation and lack the capacity to programmatically adapt to the different and ever-changing data compliance regulations. Indeed, outside of these techniques, organizations have no means of extracting information programmatically from data usage restrictions and turning such knowledge into actionable data compliance constraints that workload engines can parse, and use in order to instrument the deployment of an application subject to data sovereignty obligations and other rules across different regions. Multi-cloud and edge functionalities pose additional layers of complexity.

The techniques described herein, therefore, may provide these functionalities by leveraging the commonalities, the wide reuse of terms, and the semantic relatedness between the various concepts that are subject to data protection and other data regulations across different regions and industries. Exploiting the solution space for data compliance constraints being discrete, bounded, and sparse, the described techniques introduce programmatic extraction of data usage restrictions from various possible sources, along with automated inference of actionable data compliance constraints for applications subject to data sovereignty and other compliance rules, which may apply across different geographical locations, multi-cloud, and edge.

For example, the techniques described herein provide the programmatic extraction of data usage restrictions from various possible sources, including regulatory documents and ontology-based inputs capturing such restrictions. Further, the techniques provide automated rendering of data usage restriction digests both in human-readable and machine-readable formats representing the data compliance obligations extracted from various expressions of data usage restrictions, including regulatory documents and ontology-based inputs capturing such obligations. The techniques may provide both semi-automated and automated auditing of the computed data usage restrictions. Furthermore, the techniques provide for approval, refinement, and/or re-computation of the extracted data usage restrictions based on the semi-automated and automated auditing results. Moreover, these techniques enable the storage and reuse of human-readable and machine-readable data usage restriction digests capturing data compliance regulations at province, state, national, multi-country, and industry level across several geographical locations. The techniques provide for the use of such data usage restriction digests and the automatic inference of actionable data compliance constraints for applications subject to various data sovereignty and compliance rules, which may apply across different geographical locations, multi-cloud, and edge.

As such, the techniques provide a mechanism, configured to involve varying levels of automation, to determine, dynamically update, and/or implement the set of data compliance constraints that must be applied to an application service in order to satisfy various data handling obligations. The techniques may be utilized by organizations using and/or managing application services in various industries (e.g., healthcare, financial, energy, and other sectors) as well as by SaaS providers. These techniques may enable infrastructure-neutral data compliance controls allowing organizations to reduce the complexity, risks, and cost of dealing with data compliance (from multi-cloud to edge). The techniques may guarantee and future-proof residency/compliancy for applications used by the organizations and may be utilized to resolve and/or grant data compliance dynamically without complex and extensive re-engineering efforts. The techniques may be applied and/or utilized during the testing, staging, and production phases of an application.

While there have been shown and described illustrative embodiments to generate data compliance constraints, it is to be understood that various other adaptations and modifications may be made within the spirit and scope of the embodiments herein. For example, while certain embodiments are described herein with respect to using the techniques herein for certain purposes, the techniques herein may be applicable to any number of other use cases, as well.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
extracting, by a device and from one or more bodies of text, a data usage restriction for a particular type of data, utilizing statistical or non-statistical techniques of extraction;
sending, by the device and to a user interface, the data usage restriction extracted from the one or more bodies of text for presentation to a user;
receiving, at the device and via the user interface, feedback from the user regarding the data usage restriction; and
generating, by the device, a data compliance constraint that controls how an application service handles the particular type of data, based on the data usage restriction and the feedback from the user; wherein the device utilizes a data compliance rule repository supporting compliance engine to programmatically generate the data compliance constraints.

2. The method as in claim 1, wherein the data compliance constraint is extracted from the one or more bodies of text by applying a domain-specific data compliance ontology to the one or more bodies of text.

3. The method as in claim 1, wherein the data compliance constraint indicates one or more geolocations in which the particular type of data can be stored or retained.

4. The method as in claim 1, wherein the data compliance constraint indicates one or more geolocations from which the particular type of data can be accessed.

5. The method as in claim 1, wherein the data usage restriction indicates how the particular type of data can be utilized.

6. The method as in claim 1, further comprising:
providing the data compliance constraint generated by the device to a workload engine associated with the application service that manages a deployment of the application service to a networked infrastructure according to the data compliance constraint.

7. The method as in claim 1, further comprising:
updating the data compliance constraint in response to detecting a change in the one or more bodies of text.

8. The method as in claim 1, further comprising:
extracting the data usage restriction from the one or more bodies of data based on an industry associated with the user.

9. The method as in claim 1, wherein the feedback indicates an additional restriction to the data usage restriction.

10. The method as in claim 1, wherein the one or more bodies of text comprise a law, regulation, or industry rule.

11. An apparatus, comprising:
one or more network interfaces;
a processor coupled to the one or more network interfaces and configured to execute one or more processes; and
a memory configured to store a process that is executable by the processor, the process when executed configured to:
extract, from one or more bodies of text, a data usage restriction for a particular type of data, utilizing statistical or non-statistical techniques of extraction;
send, to a user interface, the data usage restriction extracted from the one or more bodies of text for presentation for a user;
receive, via the user interface, feedback from the user regarding the data usage restriction; and
generate a data compliance constraint that controls how an application service handles the particular type of data, based on the data usage restriction and the feedback from the user; wherein the device utilizes a data compliance rule repository supporting compliance engine to programmatically generate the data compliance constraints.

12. The apparatus as in claim 11, wherein the data usage restriction is extracted from the one or more bodies of text by applying a domain-specific data compliance ontology to the one or more bodies of text.

13. The apparatus as in claim 11, wherein the data compliance constraint indicates one or more geolocations in which the particular type of data can be stored or retained.

14. The apparatus as in claim 11, wherein the data compliance constraint indicates one or more geolocations from which the particular type of data can be accessed.

15. The apparatus as in claim 11, wherein the data compliance constraint indicates how the particular type of data can be utilized.

16. The apparatus as in claim 11, wherein the process when executed is further configured to:
provide the data compliance constraint to a workload engine associated with the application service that manages a deployment of the application service to a networked infrastructure according to the data compliance constraint.

17. The apparatus as in claim 11, wherein the process when executed is further configured to:
update the data compliance constraint in response to detecting a change in the one or more bodies of text.

18. The apparatus as in claim 11, wherein the process when executed is further configured to:
extract the data usage restriction from the one or more bodies of data based on an industry associated with the user.

19. The apparatus as in claim 11, wherein the feedback indicates an additional restriction to the data usage restriction.

20. A tangible, non-transitory, computer-readable medium storing program instructions that cause a device to execute a process comprising:
extracting, by the device and from one or more bodies of text, a data usage restriction for a particular type of data, utilizing statistical or non-statistical techniques of extraction;
sending, by the device and to a user interface, the data usage restriction extracted from the one or more bodies of text for presentation for a user;
receiving, at the device and via the user interface, feedback from the user regarding the data usage restriction; and
generating, by the device, a data compliance constraint that controls how an application service handles the particular type of data, based on the data usage restriction and the feedback from the user; wherein the device utilizes a data compliance rule repository supporting compliance engine to programmatically generate the data compliance constraints.
